(19) United States
(12) Patent Application Publication
(10) Pub. No.: US 2003/0205575 A1
(43) Pub. Date: Nov. 6, 2003

(54) Anti-splatter cover for microwave cooking

(76) Inventor: David S. DeWinter, Luther, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/139,845

(22) Filed: May 6, 2002

(51) Int. Cl. H05B 6/80

(52) U.S. Cl. 219/725; 219/734

(57) ABSTRACT

A device for preventing food splatter during microwave cooking includes a sheet of material capable of maintaining a crease, and which has at least one crease that extends across the sheet. The device is positioned over a food disposed on an open dish with the crease extending across the dish and with the crease being at an apex of the sheet while the food is heated in a microwave oven. The invention provides a convenient, easy to use and inexpensive device and method for preventing food splatter during microwave cooking of food in an open container such as a plate or bowl.

### FIELD OF THE INVENTION

This invention relates to a device for covering foods during microwave cooking to prevent food splatters.

### BACKGROUND OF THE INVENTION

During microwave cooking, excitation of water molecules within the interior of the food causes built up pressure in the form of steam, which can erupt through the food and cause food splatter. If such splatter is allowed to ensue unabated, the interior walls of the microwave oven will become soiled with food particles, thus requiring frequent cleaning. Accordingly, it is highly desirable to provide a device that will prevent food splatter during microwave cooking, and that is relatively inexpensive and easy to use.

U.S. Pat. No. 4,721,140 to Stanley W. Coker discloses a screen device adapted to cover a container of food during cooking and heating, especially microwave cooking, in order to prevent food splatters. The container has a food support surface and an upstanding rim, and the screen device comprises a sheet of flexible, open-weave material configured in a selected geometric shape and having a surrounding peripheral edge and a margin adjacent the edge. The sheet is sized to be placed across the container and overlap the rim of the container. A plurality of weight elements are secured to the sheet at spaced-apart locations along the peripheral margin whereby the weight elements cause the margin area to hang downwardly alongside the container to maintain a central portion of the sheet in the extended position across the container. It is disclosed that the sheet of flexible material may be made of a polyester material, and that the weights may be formed of a heavy plastic material. It is stated that the weights are mounted in the hem such as by sewing. After heating the food in the microwave, the screen device may be removed and cleaned in a conventional automated dishwasher.

While the device described in U.S. Pat. No. 4,721,140 is useful for preventing food splatter onto the interior walls of a microwave oven during microwave cooking, it has several notable disadvantages. While it is conceivable that the device could be used only once and discarded, the use of a polyester sheet and heavy plastic weights sewn into the periphery of the plastic sheet would likely make the device too expensive for a single use application. As a result, it is suggested that the device be cleaned after each use, such as in a dishwashing machine. Cleaning of the device, even in a dishwashing machine, may often be regarded as an inconvenience.

U.S. Pat. Nos. 5,180,894 and 6,137,099 describe open-ended microwave cooking devices that may be useful for inhibiting, but not preventing food splatter during microwave cooking. Further, these devices, which are designed to be wrapped entirely around the item that is being heated in the microwave oven, are not well suited for use with conventional dishes, such as plates or bowls.

U.S. Pat. No. 4,989,748 to Parr Jr. et al. discloses a cover for a dish for heating or cooking food in a microwave oven. The cover is formed of microwave-transparent paper and has means for reinforcing the paper. In particular, this patent teaches a device having an open mesh frame formed of a series of varying diameter non-metallic plastic or otherwise microwave acceptable rings and a plurality of straight plastic risers. The frame is employed for supporting the paper cover over a dish containing food that is to be cooked in a microwave oven. While the patent discloses that the device is relatively inexpensive and disposable, a more economical device, which does not require a frame, would be desirable.

U.S. Pat. No. 6,137,097 discloses a pleated microwave liner bag comprising a plurality of semi-rigid liner pleats that enable the liner bag to be expanded to fit a particular microwave oven. While this device will prevent food splatter on the interior walls of the microwave oven, it is relatively expensive and complicated such that it is not an appropriate device for single use applications, yet the device will accumulate undesirable amounts of food splatter during multiple uses.

U.S. Pat. No. 4,797,523 to Kohnen discloses a cover for an open container in which material therein is to be heated in a microwave oven. The cover is made from a cellulose hydrate film and includes means defining ventilation holes therein. A problem with the cover disclosed in this patent is that the cellulose hydrate film must generally be moistened at its edges and stretched over the edges of the container and then pressed onto outer surfaces of the rim of the container in order to be retained over the food to prevent food splatter. Thus, use of the cover disclosed in this patent requires several steps, thereby reducing its convenience. Another disadvantage with the cover disclosed in this patent is that when it is used with a plate of food, wherein the food on the plate extends above the height of the rim, food will adhere to the film, resulting in waste of food and additional inconvenience associated with clean up if food adhering to the film falls off onto counters, floors, or the like when the film is removed from the container.

Known devices for controlling food splatter during microwave cooking have not achieved a low cost and ease of use that desired for routine single use applications. Accordingly, there remains a need for a simple, convenient device for preventing food splatter during microwave cooking and which is sufficiently inexpensive to justify disposal after a single use to an ordinary consumer.

### SUMMARY OF THE INVENTION

The invention provides a convenient, easy to use and inexpensive device for preventing food splatter during microwave cooking of food in an open container such as a plate or bowl. More specifically, the device may be dispensed from a box or from a roll, placed directly over food on an open container, and lifted off the open container and thrown away after the food has been heated or cooked in a microwave oven. The invention also provides a method for preventing food splatter during microwave cooking using an inexpensive, disposable anti-splatter device.

The device for preventing food splatter during microwave cooking includes a sheet of material capable of maintaining a crease, and which has at least one crease that extends across the sheet. In particular embodiments, the sheets may be pre-cut to a desired shape and size suitable for use with a particular open container or dish, such as a salad plate, a dinner plate, etc. In other particular embodiments, the device may be provided with tabs which project outwardly from edges of the sheet. Such tabs may be used as lift handles to facilitate easy removal of the device. In certain embodiments, a small patch of adhesive may be used to help retain the device on an open container. In certain other embodiments, perforations, such as holes, cuts or slits may be provided for improved venting. The devices may be provided in pre-cut, pre-folded configurations which may be stacked and boxed ready for use. In other embodiments of the invention, the devices may be provided in a roll format in which a continuous sheet of material is pre-cut to form a plurality of adjacent anti-splatter devices in accordance with the invention which are separable from each other at the time of use by tearing along a line in the roll, which may be pre-scored, to separate individual devices from the roll.

The invention also provides a method for preventing food splatter during microwave cooking by providing a sheet of material capable of maintaining a crease, folding the sheet to form a crease that extends across the sheet, and positioning the creased sheet over food disposed on an open container with the crease extending across the dish.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a top plan view of a device for preventing food splatter during microwave cooking.

FIG. 2 is a perspective view of the device of FIG. 1 shown disposed over a plate of food.

FIG. 3 is a perspective view of a device for preventing food splatter during microwave cooking, which has a plurality of perforations to enhance venting of steam during microwave cooking.

FIG. 4 is a top plan view of a device for preventing food splatter during microwave cooking having a polygonal shape.

FIG. 5 is a top plan view of a device for preventing food splatter during microwave cooking having a polygonal shape and two creases which extend across the device.

FIG. 6 is a top plan view of a device for preventing food splatter during microwave cooking having a teardrop geometrical shape.

FIG. 7 is a top plan view of a device for preventing food splatter during microwave cooking having a polylobal geometric shape.

FIG. 8 is a top plan view of a device for preventing food splatter during microwave cooking having a fluted geometric shape.

FIG. 9 is a top plan view of a device for preventing food splatter during microwave cooking having a generally rectangular shape with rounded corners.

FIG. 10 is a top plan view of a device for preventing food splatter during microwave cooking having a generally circular shape with tabs projecting outwardly from opposite sides of the generally circular shape.

FIG. 11 is a perspective view of a boxed roll of sheet material capable of maintaining a crease, which is pre-folded and scored to allow selective tearing along the scores to obtain devices for preventing food splatter during microwave cooking having different sizes and/or shapes.

FIG. 12 is a perspective view of a boxed roll of sheet material capable of maintaining a crease, which has been pre-folded and pre-cut to a desired geometric shape to facilitate easy dispensing of devices for preventing food splatter during microwave cooking.

### DETAILED DESCRIPTION OF PREFERRED EMBODIMENTS

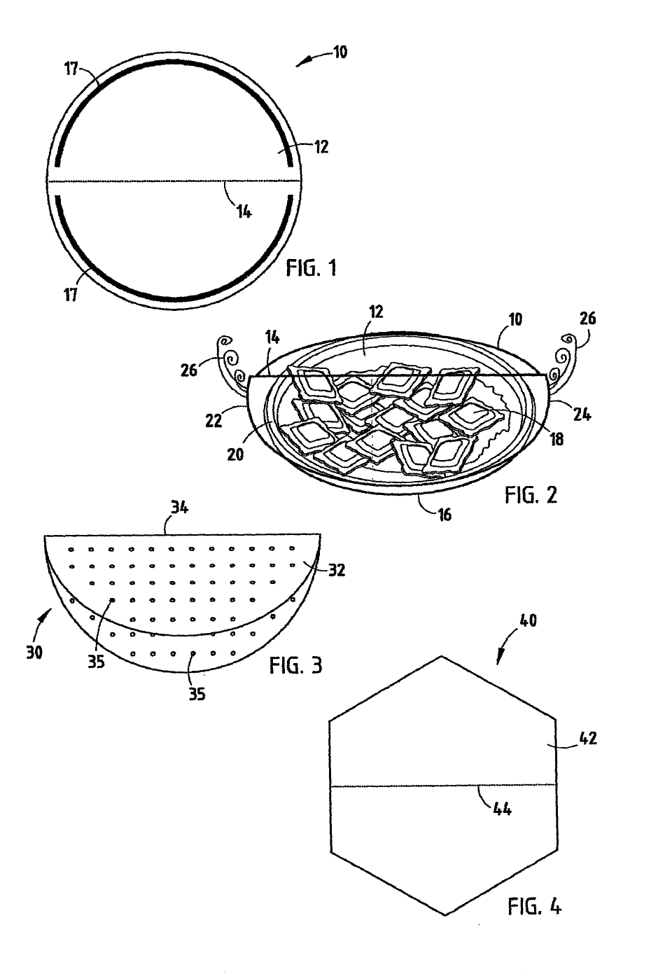

In FIG. 1 there is shown a device 10 for preventing food splatter during microwave cooking. Device 10 comprises a sheet 12 of material which is capable of being folded and maintaining a crease. Suitable sheet materials that may be utilized include various types of paper and/or parchment. Most thin plastic films, such as polyethylene film, are not well suited for use in the invention because they do not have the stiffness and other properties needed for maintaining a crease. Further, the devices of this invention are preferably comprised of a sheet of material having sufficient stiffness such that contact of the device with food on an open container due to sagging of the device is reduced relative to that of a conventional thin plastic film such as polyethylene film. Examples of suitable sheet materials include waxed paper (paper that is coated or otherwise treated with wax to make it waterproof and greaseproof), freezer paper (a generally white, relatively stiff paper commonly used for wrapping meat), parchment, and the like.

Sheet 12 is desirably cut into a shape that generally conforms with the shape of the container on which it is to be used. As most dishes have a circular shape, a preferred geometrical shape for sheet 12 is a circular shape as shown in FIG. 1. However, various other shapes, such as those shown in FIGS. 4 through 9 may be utilized, and may be desirable for certain applications.

Device 10 is comprised of a sheet 12 that is folded to form a crease 14 that extends across sheet 12. As shown in FIG. 2, device 10 is positioned over a plate 16 of food 18, such that the food is completely covered by sheet 12. Preferably, sheet 12 is cut into a geometric shape and size so that it also covers edges 20 of a container or dish 16. Sheet 12 is placed over food 18 and dish 16 so that crease 14 is located at the apex of a tent-like configuration. This minimizes contact between sheet 12 and food 18 and forms vents 22 and 24 at opposite ends of sheet 12 beneath crease 14 to allow steam 26 to escape during microwave cooking of food 18. Adhesive beads 17 may be provided along edges of sheet 12 to enhance retainment of device 10 on an open food container.

As shown in FIG. 3, a device 30, generally similar to device 10, and including a creaseable sheet material 32 having a crease 34, is provided with a plurality of perforations 35 to allow enhanced ventilation of steam from food being heated or cooked in a microwave oven. Perforations 35 may be circular holes as shown in FIG. 3, or elongate holes, cuts, slits or the like. The perforations are preferably uniformly sized and spaced apart over sheet 32 to facilitate uniform venting of steam from food being cooked in a microwave oven.

FIG. 4 shows a device 40 which is generally similar to device 10, but has a polygonal shape rather than a circular shape, more specifically a hexagonal shape. Device 40 comprises a sheet 42 having a crease 44 which extends from the midpoint of one side of the hexagonal-shaped sheet 42 to the midpoint of an opposite side of sheet 42.

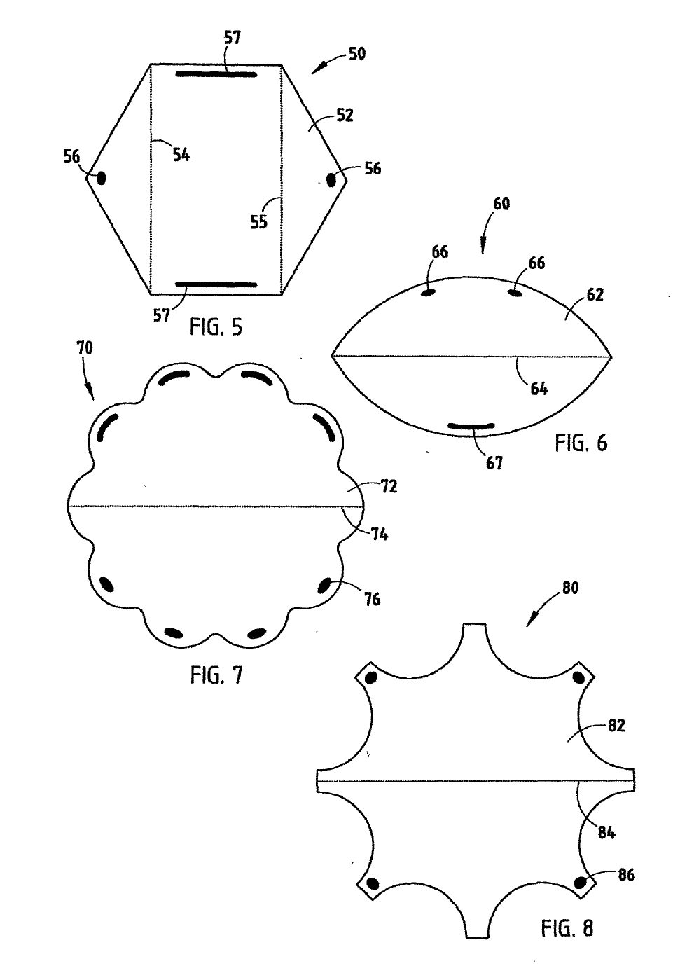

FIG. 5 shows a device 50 similar to device 40, but having two parallel creases 54 and 55 extending across sheet 52 between vertices on opposite sides of hexagonal-shaped sheet 52. When device 50 is placed over food on an open container or dish with creases 54 and 55 located at an apex, a double tent-like structure is formed having four vents. This allows enhanced venting of steam from food during microwave cooking as compared with devices show in FIGS. 1 and 4. Adhesive patches 56 and/or adhesive beads 57 may be provided at opposite corners and/or edges of sheet 52 to enhance retainment of device 50 on an open food container.

FIG. 6 shows a device 60 for preventing food splatter during microwave cooking which comprises a sheet of material 62 having a teardrop geometric shape and a crease 64 extending lengthwise across sheet 62. Device 60 may be useful for heating foods on an oblong or oval serving dish or the like. Adhesive patches 66 and/or adhesive beads 67 may be provided along edges of sheet 62 to enhance retainment of device 60 on an open food container.

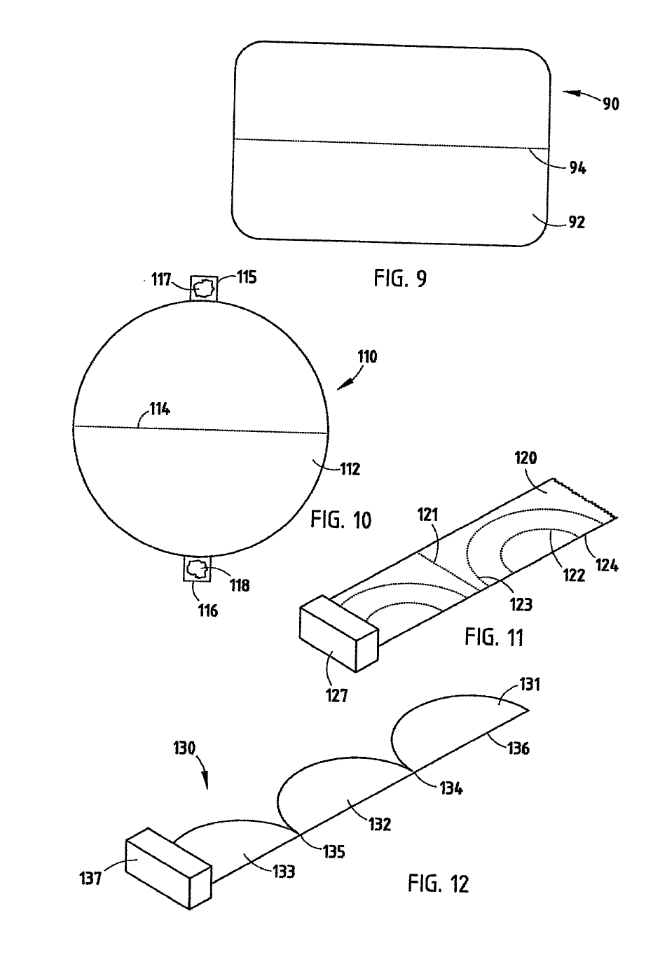

FIG. 7 shows a device 70 for preventing food splatter during microwave cooking comprising a sheet of material 72 having a polylobal geometric shape with a crease 74 extending across sheet 72. Adhesive may be provided at locations 76 along the edge of sheet 72. FIG. 8 shows a device 80 for preventing food splatter during microwave cooking comprising a sheet of material 82 having a fluted geometric shape and a crease 84 extending across sheet 82. Adhesive patches 86 may be provided at location near the edge of sheet 82 to facilitate retainment of device 80 on an open food container during cooking. FIG. 9 shows a device 90 comprising a sheet of material 92 having a generally rectangular shape with rounded corners, and a crease 94 extending lengthwise across sheet 92.

FIG. 10 illustrates an alternative embodiment of the invention which is generally similar to device 10 show in FIG. 1. In this embodiment, a device 110 for preventing food splatter during microwave cooking includes a sheet of material 112 that is folded to form a crease 114 that extends across sheet 112. Device 110 is provided with tabs 115 and 116, which in the illustrated embodiment project outwardly away from opposite edges of sheet 112. Tabs 115 and 116 may be formed by cutting a sheet material so that it has integrally attached tabs, or tabs 115 and 116 may be added after sheet 112 is cut into a desired geometric shape. For example, separately formed tabs 115 and 116 may be attached to sheet 112 with an adhesive. A patch 117 of adhesive, preferably a low-tack adhesive, may be applied to tab 115 and a similar patch of adhesive 118 may be applied to tab 116 whereby device 110 may be secured to the rim of an open container to prevent free convection or forced convection from causing device 110 to blow away from the open food container during microwave cooking or heating of food on the container.

FIG. 11 shows a boxed roll of sheet material 120 which is pre-scored as indicated by score lines 121, 122 and 123. Sheet material 120 is folded in half along crease line 124 before it is rolled. Accordingly, FIG. 11 only shows half of the sheet material that has been unrolled, the other half of the sheet material being disposed underneath the illustrated half of the sheet material, with the score lines on the half of the sheet material which is not illustrated being a mirror image of the illustrated score lines 121, 122 and 123, such that material can be unrolled and a device for preventing food splatter during microwave cooking may be separated from the roll by tearing along score line 121. The resulting device will have a generally rectangular or square shape when panels on opposite sides of crease line 124 are unfolded. The resulting square or rectangular-shaped device may be placed directly over food on an open container with the anti-splatter device orientated so that crease line 124 is at an apex of a tent-like structure during heating of the food in a microwave oven. Alternatively, the material may be torn along score line 123 to provide an anti-splatter device configured to conform to the size and shape of a large circular open container, such as a dinner plate, or along score line 122 to provide an anti-splatter device that conforms to the shape and size of a smaller dish or container, such as a dessert plate. Sheet material 120 may be unrolled and dispensed from a box 127 the way aluminum foil, plastic wrap, waxed paper and similar sheet materials are conventionally dispensed from a boxed roll.

FIG. 12 illustrates an alternative embodiment of the boxed roll shown in FIG. 11, wherein a sheet of material 130 is pre-cut to form a series of adjacent generally circular-shaped portions or segments 131, 132, 133 that are connected together at relatively narrow regions 134 between segments 131 and 132, and relatively narrow region 135 between segments 132 and 133. The pre-cut sheet material is folded in half to form crease line 136. Thereafter, the folded pre-cut sheet material is rolled and disposed in a box 137 from which segments 131, 132, 133, etc. may be individually dispensed. A device for preventing food splatter during microwave cooking is prepared for use by unrolling segment 131 from the roll and separating segment 131 from the rest of the roll by tearing along region 134. Segment 131 is then unfolded and oriented over food placed on an open container such that crease line 136 is located at an apex of a tent-like structure during microwave cooking or heating of the food.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A device for preventing food splatter during microwave cooking, comprising:
a sheet of material capable of maintaining a crease, said sheet of material having at least one crease that extends across said sheet, said sheet having a perimeter that conforms to an open food container, and an adhesive adjacent an edge of the sheet to facilitate retainment of the device on an open food container during microwave cooking of a food.

2. The device of claim 1, wherein the perimeter defines a continuous curved geometric shape.

3. The device of claim 1, wherein the perimeter defines a circular geometric shape.

4. The device of claim 1, wherein the perimeter defines a polylobal geometric shape.

5. The device of claim 1, wherein the perimeter defines a polygonal geometric shape.

6. The device of claim 1, wherein the perimeter defines a teardrop geometric shape.

7. The device of claim 1, wherein the perimeter defines a fluted shape.

8. The device of claim 1, wherein the sheet material is waxed paper.

9. The device of claim 1, wherein the sheet material is freezer paper.

10. The device of claim 1, wherein the sheet material has a plurality of perforations to allow enhanced ventilation of steam from food being heated in a microwave oven.

11. A device for preventing food splatter during microwave cooking, comprising:
a sheet of material capable of maintaining a crease, said sheet of material including at least one crease that extends across said sheet of material, and at least one tab that projects from an edge of the device, said tab providing a lift handle for removing the device from an open container after use.

12. The device of claim 11, wherein the sheet of material has a perimeter defining a geometric shape that conforms generally with the shape of a food container.

13. The device of claim 12, wherein the perimeter defines a generally circular geometric shape, with the tabs projecting from the edges of the generally circular perimeter.

14. The device of claim 12, wherein the perimeter defines a generally polygonal shape, with the tabs projecting from the edges of the generally polygonal shaped perimeter.

15. The device of claim 14, wherein the perimeter defines a generally hexagonal shape.

16. The device of claim 12, wherein the perimeter defines a generally teardrop shape, with the tabs projecting from the edges of the generally teardrop shaped perimeter.

17. The device of claim 12, wherein the perimeter defines a generally fluted shape, with the tabs projecting from the edges of the fluted perimeter.

18. The device of claim 11, wherein an adhesive is applied to said tab, whereby the device may be secured to the rim of an open container.

19. The device of claim 11, wherein the sheet material is waxed paper.

20. The device of claim 11, wherein the sheet material is freezer paper.

21. The device of claim 11, wherein the sheet material has a plurality of perforations to allow enchanced ventilation of steam from food being heated in a microwave oven.

22. A method for preventing food splatter during microwave cooking, comprising:
providing a sheet of material capable of maintaining a crease;
forming a crease in said sheet of material that extends across said sheet of material; and
positioning the creased sheet of material over a food disposed on an open dish with the crease extending across the dish, and with the crease being at an apex of the sheet while the food is heated in a microwave oven.

23. A boxed roll of creaseable sheet material which is pre-cut or pre-scored to define a series of adjacent separable segments, each segment having a crease that extends across the segment.

24. A device for preventing food splatter during microwave cooking, comprising:
a sheet of material capable of maintaining a crease, said sheet of material having at least one crease that extends across said sheet, said sheet having a perimeter that conforms to an open food container, and said sheet having a plurality of uniformly sized and spaced apart perforations which facilitate uniform venting of steam from food being cooked in a microwave oven.

25. The device of claim 24, wherein said sheet includes at least one tab that projects from an edge of the device, said tab providing a lift handle for removing the device from an open container after use.

26. The device of claim 24, further comprising an adhesive adjacent an edge of the sheet to facilitate retainment of the device on an open food container during microwave cooking of a food.

27. A device for preventing food splatter during microwave cooking, comprising:
a sheet of material capable of maintaining a crease, said sheet of material having at least one crease that extends across said sheet, said sheet having a perimeter that defines a continuous curved geometric shape.

28. The device of claim 27, wherein the perimeter defines a circular geometric shape.

29. The device of claim 27, wherein the perimeter defines a polylobal geometric shape.
